(19) United States
(12) Patent Application Publication
(10) Pub. No.: US 2014/0093629 A1
(43) Pub. Date: Apr. 3, 2014

(54) METHOD FOR THE PREPARATION OF STABILIZED RICE BRAN FINE POWDER

(71) Applicant: Wen-Kung YEN, Chang-Hua Hsien (TW)

(72) Inventor: Chung-Cheng LU, Chang-Hua Hsien (TW)

(73) Assignee: Wen-Kung Yen, Chang-Hua Hsien (TW)

(21) Appl. No.: 14/040,895

(22) Filed: Sep. 30, 2013

(30) Foreign Application Priority Data
Sep. 28, 2012 (TW) 101135952

(51) Int. Cl. A23L 1/10

(52) U.S. Cl. CPC A23L 1/1016
USPC 426/463

(57) ABSTRACT

A process for the production of stabilized rice bran fine powder is described. The process comprises adjusting the moisture content of the rice bran, deactivating rice bran lipases and peroxidases using superheated steam, drying the stabilized rice bran, and pulverizing the dried stabilized rice bran using a turbulent powdering machine with the concomitant introduction of a liquefied inert gas.

### BACKGROUND OF THE INVENTION

a) Field of the Invention

The present invention relates to a method for the preparation of stabilized rice bran fine powder, and more particularly to a method that deactivates rice bran lipases to form the stabilized rice bran and then to grind the stabilized rice bran into fine powder, so that the stabilized rice bran fine powder can be preserved in room temperature and can be used conveniently in formulas of all kinds of processed foods.

b) Description of the Prior Art

The rice bran takes about 10% of weight in paddy and is a byproduct when brown rice is milled into white rice. The rice bran contains 18-24% of fat, 25% of dietary fiber, 14% of protein and 45% of carbohydrate; whereas Amino acid of the rice bran protein is comparable to milk casein. The rice bran is enriched in the vitamin-B group, the vitamin-E group including tocopherols and tocotrienols, mineral elements such as potassium, magnesium and phosphorus, many kinds of ingredients with an antioxidation effect such as γ-oryzanol and β-sitosterol, as well as γ-aminobutyric acid with a physiological regulation function. The rice bran can be a supplement of many nutrients in food processing. However, using the rice bran as a food product or feed is limited to stability resulting from rice bran hydrolysis and oxidative rancidity. After milling the rice, the fat in the rice bran can be degenerated quickly due to the function of lipases and peroxidases and thus the rice bran is not suitable to be used as the food product.

Therefore, many processing methods have been brought up to inhibit the function of the rice bran lipases. For example, as disclosed in a Japanese Unexamined Patent Application Publication No. Sho 62-11052, the rice bran with 12˜13% of moisture content is dried to the rice bran with 8˜9% of moisture content, and the rice bran is then heated up to the rice bran with 8˜9% of moisture content at 115˜125° C. by an extruding machine with superheated steam. Next, the moisture content of the rice bran is reduced to 4˜5% at the same temperature, thereby resulting in the stabilized rice bran. However, the stabilized rice bran is not further grinded to decrease grain size.

A Japanese Unexamined Patent Application Publication No. Hei 11-9207 discloses a device that combines with a rice polisher to heat up the milled rice bran, which deactivates the lipases while heating up the rice bran at 100˜130° C. for 10˜60 seconds. The indirect heat source used is superheated steam at 160° C. and there is no limitation to the moisture content and the grain size of the rice bran.

A U.S. Pat. No. 5,753,283 discloses a method for processing the rice bran with protease to deactivate the rice bran lipases. The protease originates from plant or microorganism, such as flavourzyme, bromelin or fungal enzyme. To facilitate the protease reaction, 10% to 500% of water by weight should be added to the rice bran; it requires 24 hours to deactivate the lipases if only 10% of water is added and only 5 minutes for 500% of water. However, a lot of energy will be spent for a subsequent dehydration process.

In a P. Loypimai, et. al. report, by adjusting the moisture content of the rice bran to 30˜40% and performing ohmic heating at 150˜225 V/cm of electric field intensity, the activity of the rice bran lipases can be destroyed. However, the report is only limited to a small-scaled laboratory test, and further confirmation is needed to achieve industrialized utilization.

A research paper No. 870 published by the US Louisiana State University in January 2000 describes a dry heating method and a wet heating method for deactivating the rice bran lipases. For the dry heating method, temperature should be at least 120° C. However, many nutritious ingredients will be destroyed under this high temperature. For the wet heating method, on the other hand, temperature in a water steam heating process is difficult to be uniformly distributed, causing incomplete blanch. Yet, the preferred way is still the wet heating method and the moisture content of the rice bran should be increased to 30% or more, and the preferred wet heating method is the extrusion cooking process or the microwave heating method. Nevertheless, a large amount of water should be removed after the heating process to prevent from degeneration by development of microorganism during storage. After processing, the rice bran with the deactivated lipases is often called the stabilized rice bran which can be used as a food product enriched in protein, fat, vitamin-B and sitosterol that is able to decrease cholesterol.

A PROC Invention Patent Publication No. CN 1935963A discloses a method for extracting rice bran oil. A bedding of 20˜100 mm of thickness of the rice bran is first processed with 600˜1000 W of power for 60˜120 seconds. After processing, the moisture content of the rice bran will be 7.4%. Next, the rice bran oil is extracted with supercritical carbon dioxide at 25˜60° C. of extraction temperature, 10˜40 Mpa of extraction pressure, 15˜90 L/hr of CO₂ flow rate and 30˜150 minutes of extraction time. The yield of the rice bran oil will be 20˜22%. The ultimate object of the patent is to extract the rice bran oil, without mentioning the distribution of the rice bran oil on the rice bran grains after blanching.

A PROC Invention Patent Publication No. CN 86105295A discloses another device for extracting the rice bran oil and a processing method thereof. The rice bran is heated to 125° C. or higher for less than 1 minute with an extrusion heater and then the rice bran is quickly depressurized to atmospheric pressure, allowing the moisture in the rice bran to vaporize quickly, which causes rupture of oily cells, separation of oil with powder, destroy of lipases, and loss of growth inhibitors along with the vaporization of the moisture. Yet, the patent does not mention the post-processing of the rice bran after blanching.

A PROC Invention Patent Publication No. CN 101301004A discloses a method for processing brown rice with a high-voltage pulse electric field to form the stabilized rice bran. The newly milled brown rice is processed with an electric field of 2˜85 KV/cm of intensity, 10 μs˜10 ms of pulse width and 400˜100,000 pulses of strength. This process is normally called the ohmic heating method. However, the material processed by the patent is the newly milled brow rice which is not the same as the newly milled rice bran to be processed by the present invention.

A PROC Invention Patent Publication No. CN 101301006A discloses a method for stabilizing the rice bran using microwave heating to process newly milled brown rice. The brown rice is heated for 10 seconds to 10 minutes with microwave of 2450 MHz or 915 MHz of frequency to remove the activity of lipases. The material processed in the patent is the newly milled brown rice which is different from the newly milled rice bran to be processed by the present invention.

A US Patent Application No. 20090155439 discloses a method for removing lipases and peroxidases by heating rice bran, wheat bran and oat bran to 121˜160° C. and maintaining for 5 seconds to 2 minutes with an extrusion heater. However, there is no further process to reduce the grain size of the stabilized rice bran.

The rice bran grains from the milling are coarser, and some larger grains cannot even pass through a sieve of 20 meshes. If the rice bran is mixed directly with flour, taste of the product will not be as smooth as a pure bread product. The flour grains are very fine, normally between 90 and 100 meshes, and larger rice bran grains cause the product to have roughness. Therefore, the rice bran should be further processed and grinded to have the grain size comparable to that of the flour, about 100 meshes, so that the rice bran can be used with flour or corn powder. On the other hand, if the rice bran is to be used as a cosmetic material which is even finer, then the rice bran should be grinded to the grain size equal to that of pear powder, about 200 meshes.

Whether the dry heating method or the wet heating method is used to stabilize the rice bran, the object is to increase the rice bran temperature to deactivate (or blanch) enzyme. The extrusion heating, microwave heating and ohmic heating will all gelatinize starch in the rice bran at a same time and after drying the gelatinized starch, the whole rice bran will become very hard doughs, which increases the difficulty in grinding the stabilized rice bran into fine powder. Therefore, until now there is only a few fine powder product of the stabilized rice bran on the markets.

Accordingly, there is no method now to refine the stabilized rice bran, so that the rice bran fine powder can be mixed freely with other food products. The object of the present invention is to provide the industry with a method that can economically and effectively produce the stabilized rice bran fine powder.

### SUMMARY OF THE INVENTION

The primary object of present invention is to provide a method for stabilizing the rice bran and further processing the stabilized rice bran into fine powder that the stabilized rice bran fine powder can be mixed freely with other food products. The stabilized rice bran fine powder contains good protein, high dietary fiber, high vitamin-B, high antioxidant and γ-oryzanol that is able to decrease cholesterol and triglyceride.

Accordingly, the rice bran stabilization process includes the high temperature dry heating or wet heating method for deactivating the rice bran lipases and peroxidases. The dry heating method causes nutrients to be overheated and damaged easily and therefore, it is preferable to use the wet heating method. To allow the wet heating method to achieve the expected effect, it is preferable to adjust the moisture content of the rice bran to about 30% when performing the microwave heating or ohmic heating. On the other hand, when the rice bran is heated by the extruder, the moisture that was in the rice bran originally is already sufficient to deactivate the enzyme with high water activity under high temperature. However, whether performing the extrusion heating, microwave heating or ohmic heating, the rice bran starch will be gelatinized at a same time and after drying the gelatinized starch, the entire rice bran will become very hard doughs, which increases the difficulty in grinding the stabilized rice bran into fine powder.

When a conventional pulverizer is used to grind the stabilized rice bran into fine powder with a grain size comparable to that of flour that the fine powder can pass through a sieve of 100 meshes, the rice bran powder can be caked into doughs. As the rice bran is enriched in oil, the rice bran can be liquefied due to heating while grinding, causing the rice bran powder to be caked without forming powder that can flow freely. The rice bran oil is provided with complex compositions and its fatty acid is close to peanut oil, containing about 40% of polyunsaturated fatty acid, 40% of monounsaturated fatty acid and 20% of saturated fatty acid. In addition, the cloud point of the rice bran oil is only 10° C., meaning that the rice bran oil under room temperature is already liquid oil. Under a high temperature condition in a grinding chamber, the viscosity of the rice bran will be reduced and the rice bran oil can flow, allowing the rice bran to be caked into doughs. This is also the primary cause that no person can yet produce the stabilized rice bran fine powder in a large quantity. From the results of the practical tests conducted by the present inventor, when the grinding chamber temperature is more than 45° C., the rice bran powder can be caked. Therefore, the issue of the grinding chamber heating must be solved to produce find powder that can be used as a food product.

Accordingly, a method for reducing the grinding chamber temperature is disclosed. In the method, a gas from nitrogen, carbon dioxide, helium and argon is introduced as a coolant at a same time when feeding the rice bran into a pulverizer, while improving the cooling system of the pulverizer. With this method, the grinding chamber temperature can be reduced to 25° C. or even lower and the rice bran powder is fine and uniform without caking. This improved cooling system of the pulverizer has already been filed with a patent application to the Intellectual Property Office in Taiwan, with the application No. 100143838.

There are many kinds of pulverizers and depending upon a way of exerting force to the raw materials, there are functions of squeezing, bending, striking, cutting and grinding when crushing the raw materials. When the raw material is crushed to an expected grain size, the grains have to be separated with coarser grains by using a mechanical sieve or a winnowing method which uses air flow to levitate finer grains.

A conventional Jaw crusher has to be used with the sieve, allowing the raw material with the expected grain size to pass through the sieve, thereby forming the product. When this kind of pulverizer is used to produce the stabilized rice bran, the raw rice bran will be heated due to friction, so that the rice bran can be liquefied. Furthermore, the liquefied rice bran oil will agglutinate the rice bran grains into large doughs to clog the sieve. Therefore, the Jaw crusher is inappropriate. Similarly, when a roll crusher or a cone crusher is used in association with a wind mill to separate finer grains with the winnowing method, the raw rice bran is heated and the powder is caked as the cone or the roller is heated, or the rice bran powder grains are adhered on the wall of the wind pipe as the heated and liquefied rice bran oil is cooled down and condensed on the wind pipe wall to block air flow, thereby being unable to separate into the stabilized rice bran fine powder.

Accordingly, the present invention discloses a mass production method that can produce the stabilized rice bran fine powder which is able to pass through a sieve of 200 meshes.

According to the present invention, the method for producing the stabilized rice bran fine powder comprises the following steps:
(1) The rice bran obtained by milling the rice is screen selected to remove impurities.
(2) The moisture content of the rice bran is adjusted.
(3) The rice bran is heated and blanched to deactivate the rice bran lipases.
(4) The rice bran is dried to reduce the moisture content to less than 8%.
(5) The rice bran is pulverized into fine powder.

In the abovementioned step (2) of adjusting the moisture content and step (3) of heating and blanching the rice bran, if the moisture content is adjusted to about 20% to 30%, then the rice bran is heated with microwave to about 100˜110° C.

Furthermore, in the abovementioned step (2) of adjusting the moisture content and step (3) of heating and blanching the rice bran, if the moisture content is adjusted to about 15% to 30%, then the rice bran is heated with superheated steam to about 100˜110° C.

Still furthermore, in the abovementioned step (2) of adjusting the moisture content and step (3) of heating and blanching the rice bran, if one needs to keep the original moisture content of the rice bran, then the rice bran is heated with an extrusion heater and superheated steam to about 120˜140° C.

The drying process of the abovementioned step (4) can be performed by the forced draft drying method, the depressurization drying method or the hot-air drying method.

The pulverizing process of the abovementioned step (5) is performed by a turbulent powdering machine with the concomitant introduction of a liquefied inert gas to reduce the grinding temperature.

The embodiments 1 and 2 described below will disclose the method for deactivating the lipases with microwave heating and extrusion heating respectively to form the stabilized rice bran fine powder. In addition, the obtained stabilized rice bran fine powder is added into flour to make high fiber bread and stability during storage is observed.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a photograph showing distribution of raw rice bran (left) and stabilized rice bran fine powder (right) in water.

FIG. 2 is a photograph comparing the expansion ratio of a round-top toast made by adding 15% or 20% of rice bran into gluten flour.

FIG. 3 shows a change of content of free fatty acid during the storage of stabilized rice bran fine power in room temperature.

### DETAILED DESCRIPTION OF THE PREFERRED EMBODIMENTS

### Embodiment 1

### Deactivating the Lipases with Microwave Heating

Three-hundred and fifty grams of fresh rice bran from a rice miller is added with 150 g of water and is moved into a ceramic plate of 30 cm in diameter and 10 cm in height after being mixed uniformly. The ceramic plate is next covered with plastic wrap, put into a microwave oven and heated for 5 minutes in a high-temperature mode (at 1,400 W of power). After that, the ceramic plate is taken out of the microwave oven and center temperature of the rice bran is measured to be 108° C. with a thermometer. The rice bran is then put into a ventilation dryer of 105° C. for drying. The dried rice bran is pulverized to fineness that 100% of powder can pass through a standard sieve of 100 meshes and 90% of powder can pass through a standard sieve of 120 meshes with the FW-140 turbulent powdering machine of the Full-Win Technology Co., Ltd. (No. 11-1, Gou Tour Lane, Kuang Hsing Village, Erh Ling Town, Chang Hua County, Taiwan). During pulverization, the liquefied carbon dioxide is introduced into the feed port of the powdering machine along with the rice bran. The turbulent powdering machine uses primarily a grinding element that spins in high speed to produce turbulent, allowing the material to be grinded to collide and scratch with each other to achieve the pulverization effect.

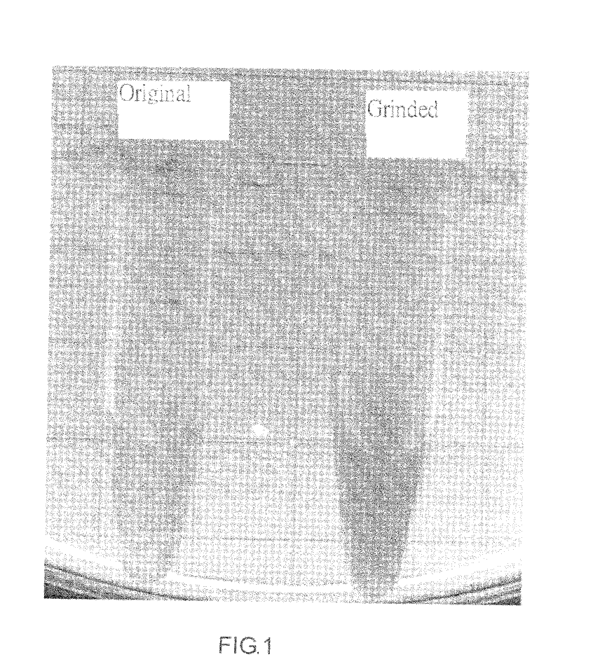

The stabilized rice bran powder and the raw rice bran are added with water respectively and vibrated uniformly to form suspension liquid. Part of the suspension liquid is then taken out and put into a cone-shaped centrifuge tube for observation. The results are shown in FIG. 1, disclosing that the raw rice bran is caked and precipitated in water, whereas the pulverized and grinded stabilized rice bran is distributed very well in water.

### Embodiment 2

### Deactivating the Lipases with Extrusion Heating

Five thousand kilograms of fresh rice bran is taken from a rice mill and is heated by a Miltenz Extruder 6000-SX (Millbank Technology, Ltd., 25-31 Elizabeth Knox Place, Auckland 6, N.Z.) at a feeding rate of 3,000 Kg/hr. The operating conditions are that sleeve temperature is 135° C. and average retention time is 10 seconds. After that, the rice bran is taken out and put in a ventilation dryer of 105° C. for drying. The dried rice bran is then pulverized to the fineness that 90% of powder can pass through the standard sieve of 120 meshes with the FW-140 turbulent powdering machine of the Full-Win Technology Co., Ltd.

Same as the embodiment 1, the stabilized rice bran is added with water and is then vibrated uniformly into suspension liquid. Part of the suspension liquid is taken out and put in the centrifuge tube for observation. It turns out that the pulverized and grinded rice bran is distributed very well in water, with appearance similar to that in FIG. 1. Therefore, no further description is needed.

### Embodiment 3

### Application of the Stabilized Rice Bran Fine Powder—Adding the Fine Powder into Gluten Flour to Make High Fiber Bread

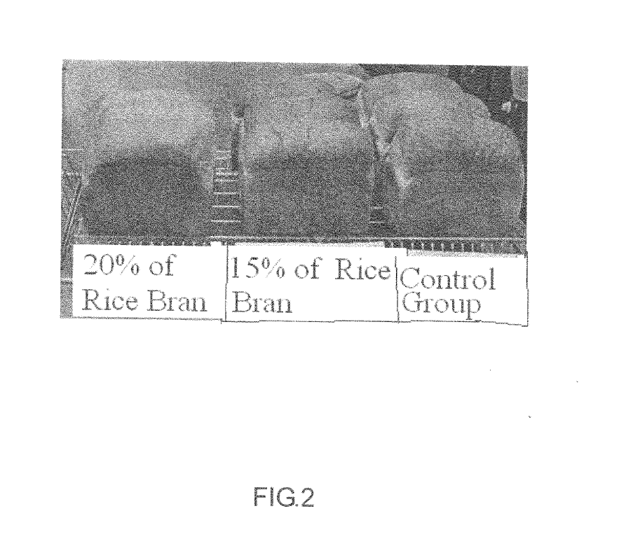

The rice bran obtained in the embodiment 2 is added into gluten flour and round-top toasts are made with the normal method. The oven is set at 210° C. and 35 minutes. All kinds of ingredients are added as shown in Table 1 and weight and height of the round-top toasts are measured as in Table 2, with the physical photograph in FIG. 2. As shown in FIG. 2, the expansion ratio of the round-top toast made by gluten flour added with 15% of stabilized rice bran fine powder is almost the same as that of the control group, the round-top toast made by pure gluten flour. In addition, there is no difference in taste and the weight ratio is better for the rice bran toasts (as shown in Table 2).

### Embodiment 4

### Stability of the Stabilized Rice Bran During Storage

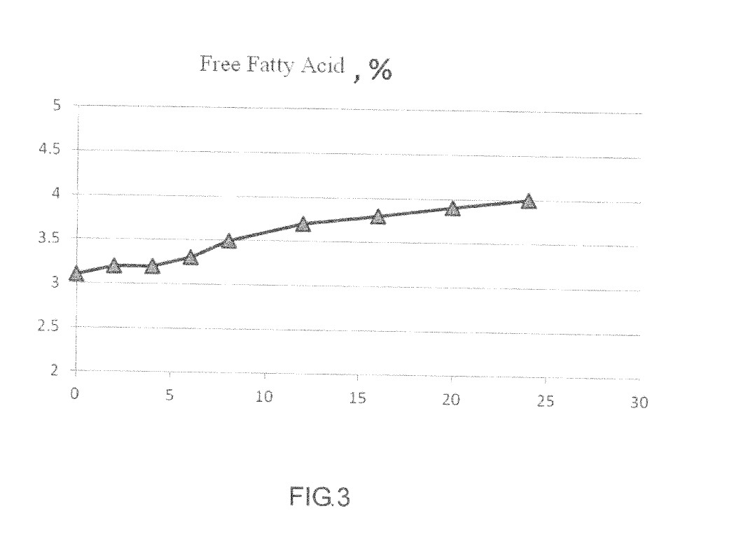

Five hundred grams of the rice bran obtained from the embodiment 2 is packaged in a polypropylene bag and is kept under room temperature (about 25˜30° C.). The rice bran is taken out regularly to analyze the content of fatty acid, according to the official methods and recommended practices of the American Oil Chemists' Society, A.O.C.S. 2004. The results are shown in FIG. 3, wherein the horizontal axis represents no. of weeks of preservation and the vertical axis is the content of free fatty acid (as Oleic acid) in the rice bran oil. The drawing shows that when the stabilized rice bran fine powder is stored in room temperature for six months, the content of free fatty acid only increases slightly from 3.1% to 4.0%, representing that the rice bran lipases have been deactivated completely. For the rice bran oil eaten by a human, the content of free fatty acid is required not to be higher than 10%. Therefore, it is obviously that the stabilized rice bran, according to the present invention, also meets this requirement.

TABLE 1
Formula of Raw Materials of Round-Top Butter Toasts (3 Rolls)

| | | 15% of | 20% of |
|---|---|---|---|
| Raw Material | Control Group | Rice Bran | Rice Bran |
| Gluten Flour, g | 928 | 788.8 | 742.4 |
| Stabilized Rice Bran | 0 | 139.2 | 185.6 |
| Fine Powder, g | | | |
| Full-Fat | 37 | 37 | 37 |
| Milk Powder, g | | | |
| Castor Sugar, g | 93 | 93 | 93 |
| Salt, g | 14 | 14 | 14 |
| Water, g | 483 | 483 | 483 |
| Egg, g | 74 | 74 | 74 |
| Quick-Rise Yeast, g | 11 | 11 | 11 |
| Butter, g | 93 | 93 | 93 |
| S-5000 (Bread Improver), g | 9 | 9 | 9 |
| Total Weight, g | 1742 | 1742 | 1742 |

TABLE 2
Measurement of Properties of Toast

| Group | Weight, g | Weight Ratio, % | Height, cm |
|---|---|---|---|
| Control Group, 1^{st} Roll | 551 | 94.9 | 17 |
| Control Group, 2^{nd} Roll | 549 | 94.5 | 17.5 |
| Control Group, 3^{rd} Roll | 529 | 91.1 | 17.5 |
| Control Group, Average | 543 | 93.5 | 17.3 |
| 15% of Rice Bran, 1^{st} Roll | 574 | 98.9 | 15.5 |
| 15% of Rice Bran, 2^{nd} Roll | 566 | 97.5 | 15.5 |
| 15% of Rice Bran, 3^{rd} Roll | 569 | 98.0 | 16.0 |
| 15% of Rice Bran, Average | 570 | 98.1 | 15.7 |
| 20% of Rice Bran, 1^{st} Roll | 563 | 97.0 | 14.5 |
| 20% of Rice Bran, 2^{nd} Roll | 553 | 95.2 | 16.0 |
| 20% of Rice Bran, 3^{rd} Roll | 559 | 96.3 | 16.0 |
| 20% of Rice Bran, Average | 558 | 96.2 | 15.5 |

It is of course to be understood that the embodiments described herein is merely illustrative of the principles of the invention and that a wide variety of modifications thereto may be effected by persons skilled in the art without departing from the spirit and scope of the invention as set forth in the following claims.

1. A method for the preparation of stabilized rice bran fine powder, comprising the following steps:
(1) Screen selecting the rice bran obtained from milling the rice to remove impurities;
(2) Adjusting the moisture content;
(3) Heating and blanching the rice bran to deactivate the rice bran lipases;
(4) Drying the rice bran to reduce the moisture content to less than 8%; and
(5) Pulverizing the rice bran into fine powder.

2. The method according to claim 1, wherein in the step (2) of adjusting the moisture content and the step (3) of heating and blanching, the moisture content is adjusted to about 20% to 30% and the rice bran is heated with microwave to about 100˜110 C.

3. The method according to claim 1, wherein in the step (2) of adjusting the moisture content and the step (3) of heating and blanching, the moisture content is adjusted to about 15% to 30% and the rice bran is heated with superheated steam to about 100˜110 C.

4. The method according to claim 1, wherein in the step (2) of adjusting the moisture content and the step (3) of heating and blanching, the moisture content is kept at the original amount and the rice bran is heated with an extrusion heater, along with superheated steam, to about 120˜140 C.

5. The method according to claim 1, wherein the drying process of step (4) is performed with the forced draft drying method, the depressurization drying method or the hot-air drying method.

6. The method according to claim 5, wherein the pulverization process of step (5) is performed with a turbulent powdering machine and during grinding, a liquefied inert gas is introduced to reduce grinding temperature.

7. The method according to claim 6, wherein the liquefied inert gas in step (6) is nitrogen, carbon dioxide, helium or argon.

8. The method according to claim 2, wherein the drying process of step (4) is performed with the forced draft drying method, the depressurization drying method or the hot-air drying method.

9. The method according to claim 3, wherein the drying process of step (4) is performed with the forced draft drying method, the depressurization drying method or the hot-air drying method.

10. The method according to claim 4, wherein the drying process of step (4) is performed with the forced draft drying method, the depressurization drying method or the hot-air drying method.
